(19) United States
(12) Patent Application Publication
(10) Pub. No.: US 2008/0106175 A1
(43) Pub. Date: May 8, 2008

(54) Fixing apparatus for preventing drawers from being linked and slid

(75) Inventor: Kuo-Sheng Huang, Taipei County (TW)

Correspondence Address: BACON & THOMAS, PLLC, 625 SLATERS LANE, FOURTH FLOOR, ALEXANDRIA, VA, 22314, US

(73) Assignee: NAN JUEN INTERNATIONAL CO., LTD., TAIPEI COUNTY (TW)

(21) Appl. No.: 11/646,380

(22) Filed: Dec. 28, 2006

(30) Foreign Application Priority Data
Nov. 7, 2006 (TW) 095219607

(51) Int. Cl. E05B 65/46

(52) U.S. Cl. 312/217

(57) ABSTRACT

The present invention discloses a fixing apparatus for preventing drawers from being linked and slid, and the apparatus includes a fixing base installed at a side of a rail and a moving element erected on a lateral side of a cabinet. The fixing base has an embedding groove, and the moving element have a latching element and a linking element eccentrically and pivotally connected to upper and lower ends of the moving element, and the latching element is latched into the embedding groove, and the latching element and linking element are respectively and pivotally connected to the adjacent linking element and latching element. If one of the drawers is pulled, the linking element drives the moving element at the top to move, so that the latching elements of other drawers are latched into the embedding groove of the fixed base to maintain those drawers at their original positions.

### BACKGROUND OF THE INVENTION

1. Field of the Invention

The present invention relates to a fixing apparatus for preventing drawers from being linked and slid, and more particularly to a fixing apparatus that allows one of the drawers to be pulled out while all other drawers remain at their original positions. The fixing apparatus drives a moving element to be moved in a minimum distance to drive a latching element to a position and latch other unpulled drawers by means of an eccentric pivotal latching element and a linking element.

2. Description of the Related Art

In a general drawer cabinet, other adjacent drawers may be pulled out unexpectedly while one of the drawers is opened. This drawback not only causes inconvenience, but also increases the risk of toppling the drawer cabinet. Therefore, present drawers usually install a safety rail and an elastic latch device to prevent users from pulling out two or more drawers at a time, but the structure of these elastic latch devices is too complicated. Specifically, a structure as disclosed in R.O.C. Pat. Publication No. 517553 includes a lock rod at a connecting area disposed on a sidewall or both sidewalls of a cabinet of a drawer, a boundary groove disposed on each layer, a propping frame element, a positioning plate element, a bolt unit and a latch element. In addition to the complexity of all these components, the design of existing cabinets have to be changed to fit the connecting area, and the assembling process is very difficult and thus such structure is not cost-effective. Mostly important, such structure involves so many components, and users have to apply a larger force to overcome the links of these components in order to pull out a drawer, and thus the rail assembly and related components may be worn out and damaged easily, and the application of such structure is very inconvenient.

To overcome the shortcomings of requiring too many components and a complicated installation, an improved structure is introduced. Referring to FIGS. 1 and 1A, the structure includes: a plurality of moving elements 100 disposed vertically and adjacent to each other on a lateral inner side of a cabinet, and restricted on an internal side at upper and lower ends of the cabinet; a spring 110 installed between the top of the uppermost moving elements 100 and the lateral inner side at the upper end of the cabinet for moving the moving elements 100 back to their original positions by the resilience of the spring 110 after the moving elements 110 are moved from their original positions; a swinging element 120 and a limit element 130 disposed at upper and lower ends of the moving elements 100 respectively; a drawer rail 200 installed on the cabinet and disposed between the swinging element 120 and the limit base 130 and vertically adjacent to the moving elements 100; a hook 121 disposed at an end of the swinging element 120 and latched onto the limit element 130 (as shown in FIG. 1); and a protruding member 122 protruded from another end of the swinging element 120.

Referring to FIG. 1A, if a drawer (which is one of drawer at the middle in this embodiment) is opened by pulled it out, a rail 200 corresponding to the drawer will be moved outward accordingly and latched, and a hook 121 latched to a limit element 130 will be moved together with the rail 200 and separated from the limit element 130, such that a swinging element 120 is swung according to the movement of the hook 121, and a protruding member 122 at another end of the swinging element 120 presses against rail 200 to move the moving elements 100 upward (and the moving distance is indicated by a in the figure), and other hooks 121 will press their corresponding limit elements 130 and maintain the limit elements still. Since the central position of the swinging element 120 is pivotally connected to the moving elements 100, the hook 121 and the protruding member 122 disposed on both sides of the swinging element 120 can be swung, such that the hook 121 can be separated from the limit element 130, and the protruding member 122 at the other end of the swinging element 120 can press on the rail 200. If only a slide of the rail 200 is moved outward, then the moving element 100 will not be moved all the way to the predetermined distance, and the corresponding hooks 121 of other drawers will not be able to move to the predetermined positions, since the moving distance is too short, and the hooks 121 cannot latch the corresponding limit elements 130 of the drawers. As a result, all these drawers will be moved outward at the same time, and the application of such device cannot meet our requirements.

### SUMMARY OF THE INVENTION

In view of the shortcomings of the conventional apparatus and structure, the inventor of the present invention based on years of experience in the related industry to conduct extensive researches and experiments, and finally developed a fixing apparatus for preventing drawers from being linked and slid in accordance with the present invention.

Therefore, it is a primary objective of the present invention to provide a fixing apparatus for preventing drawers from being linked and slid, and the fixing apparatus can maintain all other drawers at their original positions while one of the drawers is pulled out.

Another objective of the present invention is to provide a fixing apparatus for preventing drawers from being linked and slid, and the apparatus is installed on any side with an erected fixing element of a cabinet, and the fixing element contains a plurality of vertically erected and adjacent moving elements, and a latching element and a linking element are disposed respectively at upper and lower ends of the moving elements, and the latching element and linking element are pivotally connected to adjacent linking element and latching element respectively. Further the fixing element further includes an open slot corresponding to the latching element, and a latch protruded from the latching element and latched into an embedding groove of the fixing base on the rail. If one of the drawers is pulled outward, the fixing base of the rail latched to the latch will move the embedding groove outward to drive the linking element to move accordingly and press an upper moving element, such that the upper moving element can move upward to latch the corresponding latching elements of other drawer rails into the corresponding embedding grooves of the fixing base, and the drawers can be fixed at their original positions. Since the latching element and linking element are eccentrically and pivotally connected to the moving elements, the latching element and the linking element can be slid smoothly to move the moving elements in a minimum moving distance. The invention can prevent the situation that the latching element cannot be moved to its desired position due to insufficient moving space or the situation that all other unpulled drawers will be pulled out at the same time.

Another objective of the present invention is to provide a fixing apparatus for preventing drawers from being linked and slid, and the moving elements includes a protruding member passed through a lower edge in a slide slot on the fixing element, such that if one of the drawers is pulled outward, the lower drawers will be limited and its corresponding protruding member in the moving element will not be able to move downward in the slide slot, so as to maintain the lower drawers at their original positions.

To make it easier for our examiner to understand the present invention, the following embodiment accompanied with the related drawings are described in details.

### BRIEF DESCRIPTION OF THE DRAWINGS

FIG. 1 is a schematic view of a conventional structure;

FIG. 1A is a schematic view of movements of a conventional structure;

FIG. 2 is a schematic view of a latching element latched onto a fixing base of a bottom rail in accordance with the present invention;

FIG. 3 is a perspective view of a preferred embodiment of the present invention;

FIG. 4 is an exploded view of a moving element, a latching element and a linking element in accordance with the present invention;

FIG. 5 is a schematic view of movements of a moving element and a latching element in accordance with the present invention;

FIG. 6A is a first schematic view of pulling out a drawer in accordance with the present invention;

FIG. 6B is a second schematic view of pulling out a drawer in accordance with the present invention;

FIG. 6C is a third schematic view of pulling out a drawer in accordance with the present invention;

FIG. 6D is a fourth schematic view of pulling out a drawer in accordance with the present invention;

FIG. 7A is a first schematic view of movements of a moving element while a drawer is pulled out in accordance with the present invention;

FIG. 7B is a second schematic view of movements of a moving element while a drawer is pulled out in accordance with the present invention;

FIG. 7C is a third schematic view of movements of a moving element while a drawer is pulled out in accordance with the present invention;

FIG. 8A is a first schematic view of movements of a moving element while a drawer is shut in accordance with the present invention;

FIG. 8B is a second schematic view of movements of a moving element while a drawer is shut in accordance with the present invention; and

FIG. 8C is a third schematic view of movements of a moving element while a drawer is shut in accordance with the present invention.

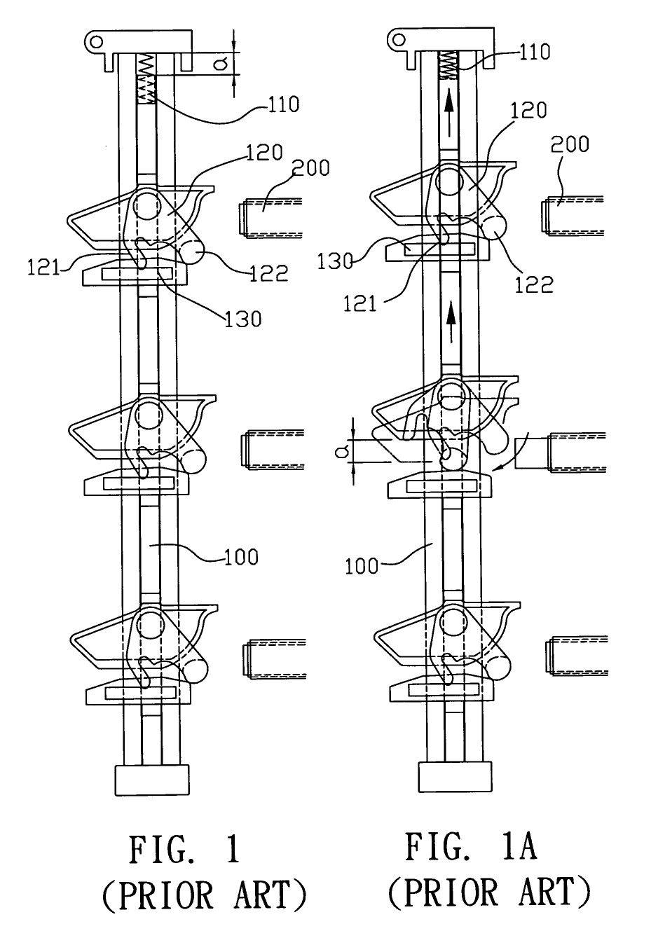

### DETAILED DESCRIPTION OF THE PREFERRED EMBODIMENTS

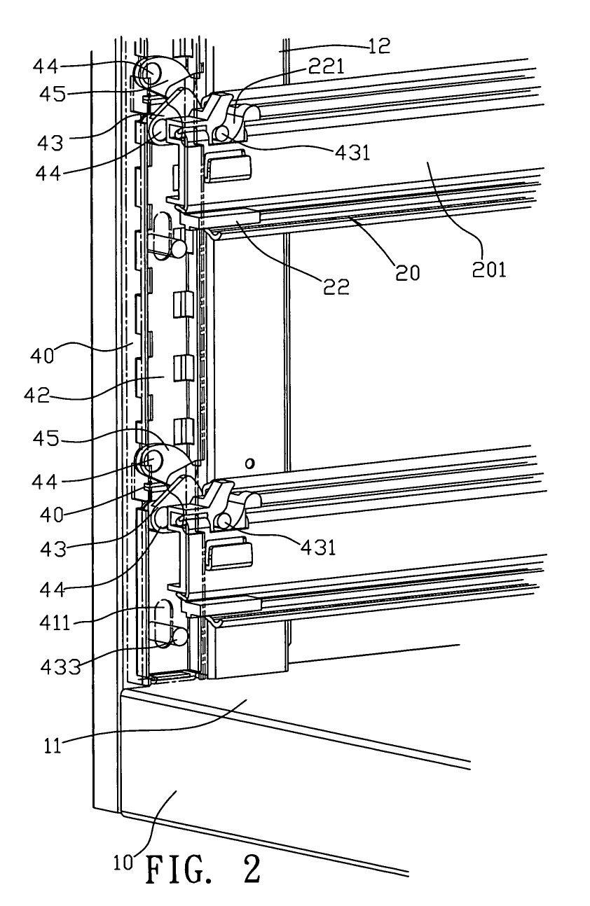

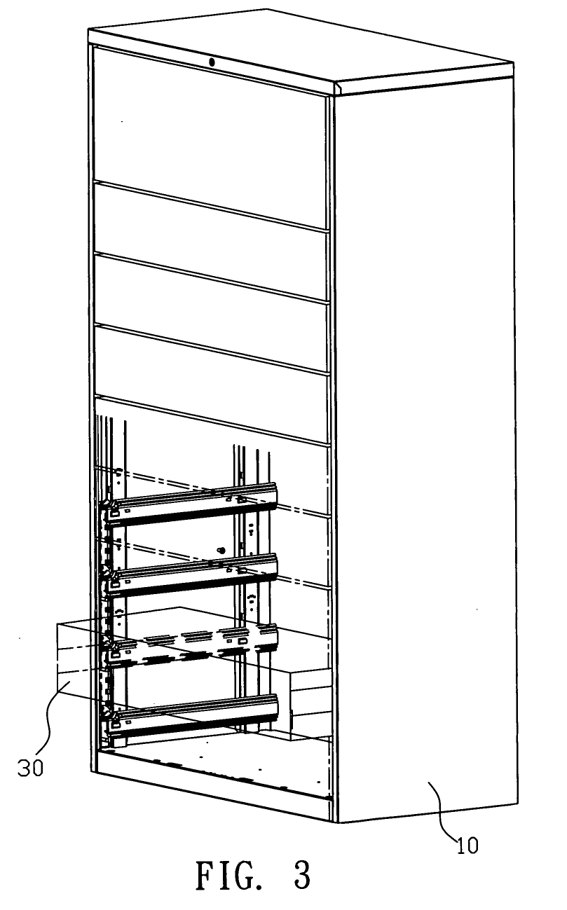

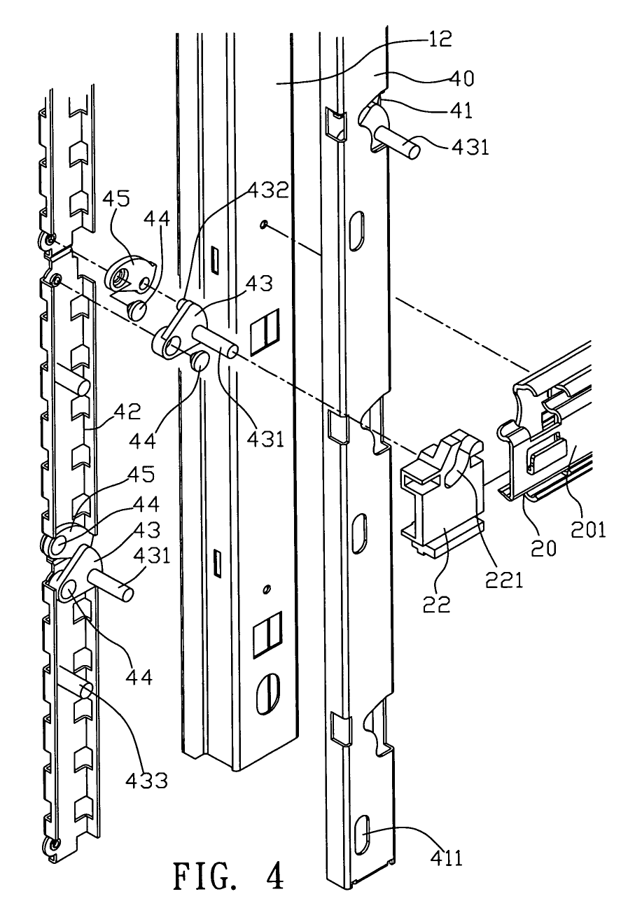

Referring to FIGS. 2 to 4 for a fixing apparatus for preventing drawers from being linked and slid in accordance with the present invention, the fixing apparatus can maintain all other drawers at their original position when one of the drawers is pulled out. The apparatus includes a cabinet 10, and the cabinet 10 includes an opening 11, and the cabinet 10 proximate to both lateral inner sides of the opening 11 has corresponding erected support stands 12, and the support stands 12 at an appropriate distance have a plurality of parallel and corresponding bottom rails 20, and the bottom rail 20 includes a rail 201 disposed thereon, and the rails 201 are coupled with the drawers 30, and an end of the rail 201 includes a fixing base 22 coupled to the rail 201, and the fixing base 22 includes an embedding groove 221.

Further, a fixing element 40 is disposed on a lateral side proximate to the support stand 12 which is a hollow frame in this embodiment, the fixing element 40 is erected adjacent to the support stand 12, and the fixing element 40 includes an open slot 41 and a slide slot 411, and the open slot 41 corresponds to the fixing base 22. Further, the fixing element 40 contains a plurality of vertically adjacent and erected moving elements 42, and the moving elements 42 can slide linearly and vertically in the fixing element 40 and the length of the moving elements 42 is approximately equal to the distance between two open slots 41. A latching element 43 and a linking element 45 are disposed on an end proximate to an position between the adjacent moving elements 42 and corresponding to each other, and the latching element 43 corresponds to the open slot 41, and a latch 431 of the open slot 41 is protruded from a surface of the latching element 43, and the latch 431 can be latched into the embedding groove 221 of the fixing base 22. Further, an end of the latching element 43 is eccentrically and pivotally connected to an upper end of the moving elements 42 by a pivotal shaft 44, and another side of the latching element 43 has a protruding pillar 432 disposed on an axis other than those of the latch 431 and the pivotal shaft 44. The protruding pillar 432 is pivotally connected to the adjacent linking element 45, and the linking element 45 is eccentrically and pivotally coupled to the moving element 42 by a pivotal shaft 44. The moving element 42 has a protruding member 433 disposed at a position other than those of the latching element 43 and the linking element 45, and the protruding member 433 can be passed through a lower edge in the slide slot 411 of the fixing element 40 and limited in the slide slot 411.

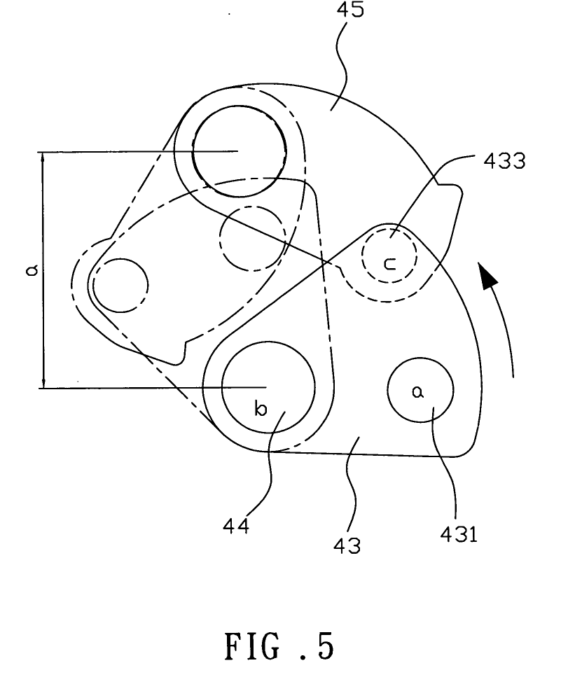

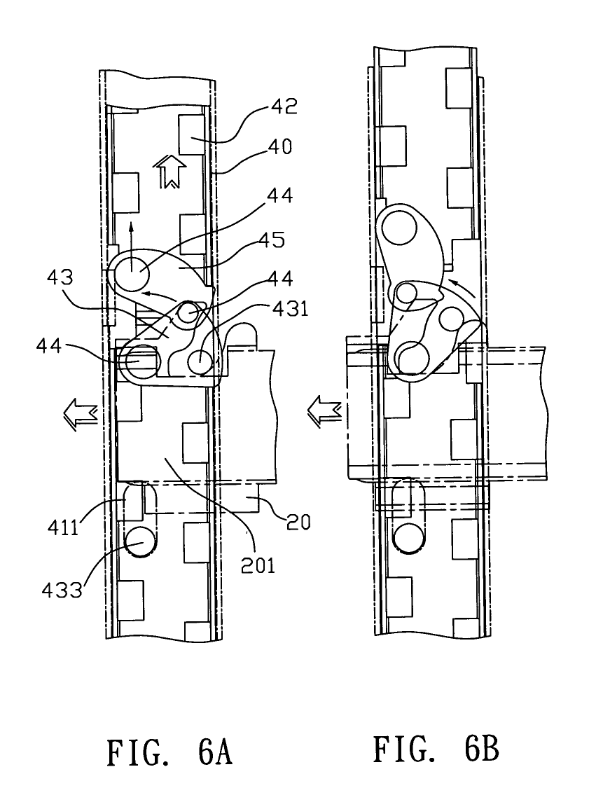

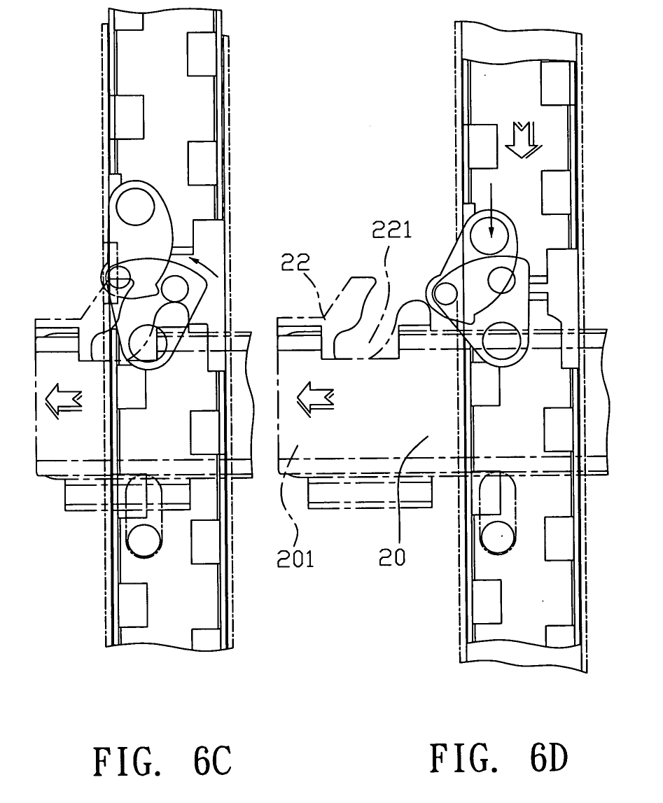

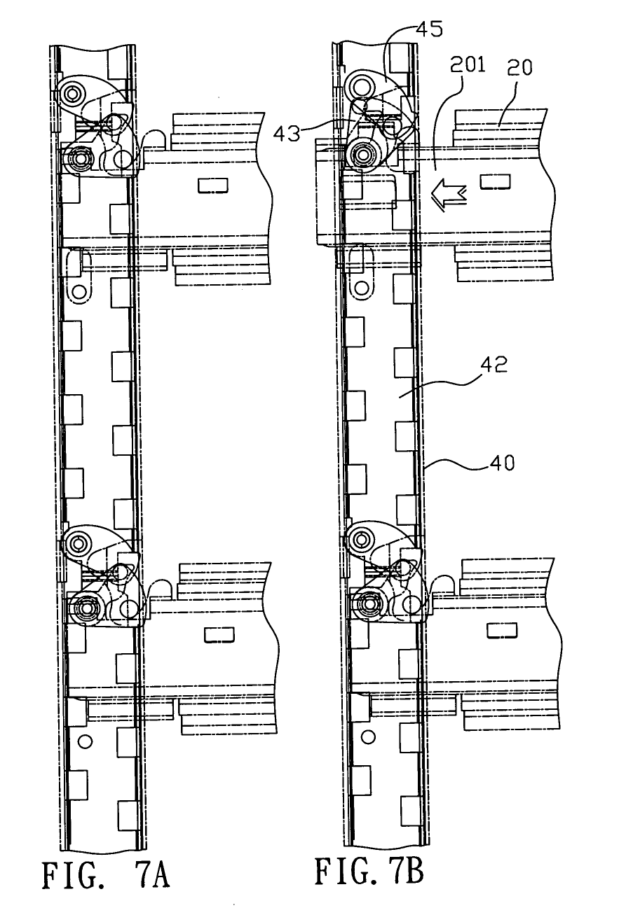

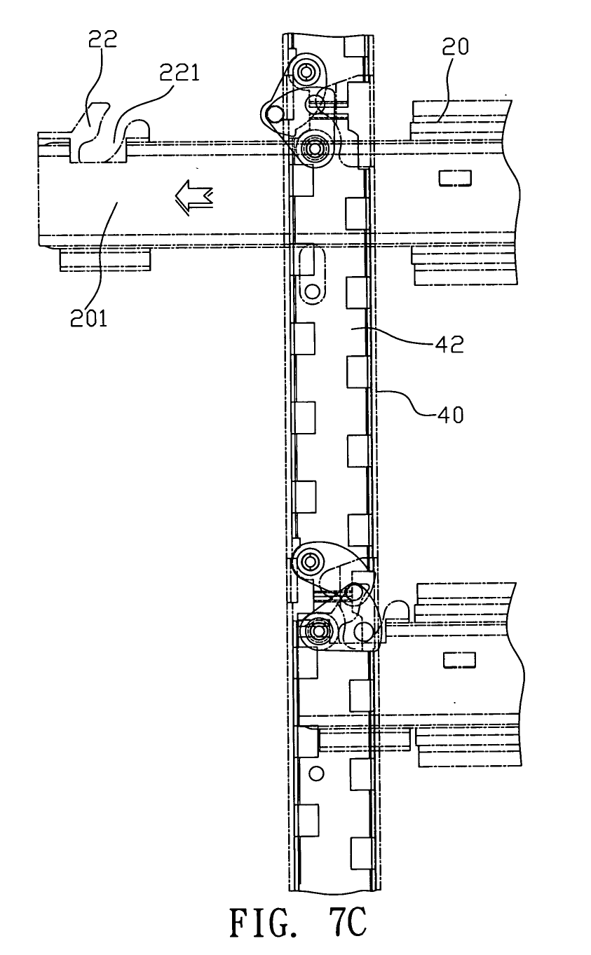

Referring to FIGS. 5, 6A, 6B, 6C, 6D, 7A, 7B and 7C, if a drawer 30 (not shown in the figure) is pulled outward, a rail 201 connected to a drawer 30 will be moved outward accordingly to driver a latch 431 in the embedding groove 221, so that the latch 431 in the fixing base 22 will move out from the embedding groove 221 and press against an edge of the embedding groove 221, and the pivotal shaft 44 is used as an axle center to move circumferentially upward. Meanwhile, the protruding pillar 432 drives the linking element 45 to move accordingly and drive the upper moving elements 42 to move upward, such that the upper drawers 30 will remain latched with the corresponding latching element 43 and will not move outward. In the meantime, the limit of the protruding member 433 keeps the lower moving elements 42 from moving downward, and thus the lower drawers 30 will be still latched to the corresponding latching elements 43 and will not move outward.

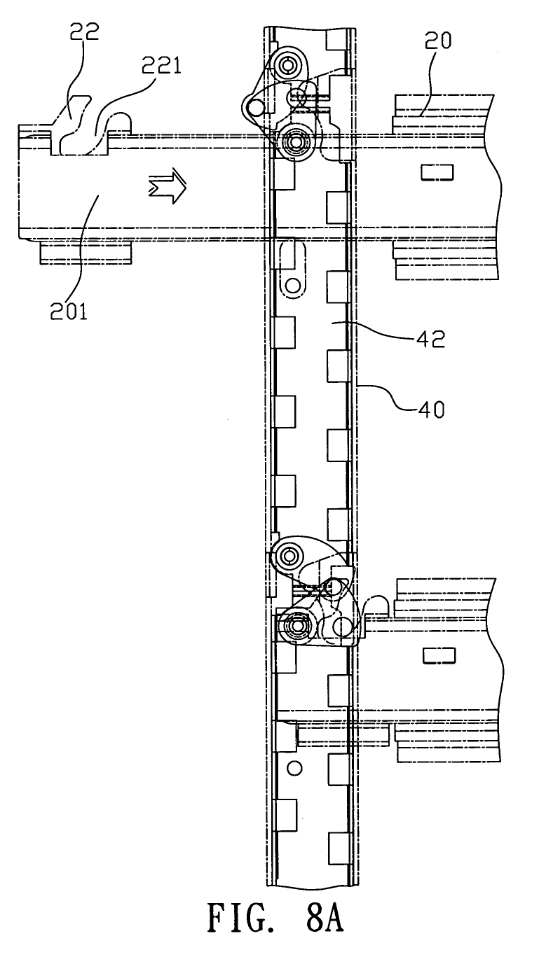

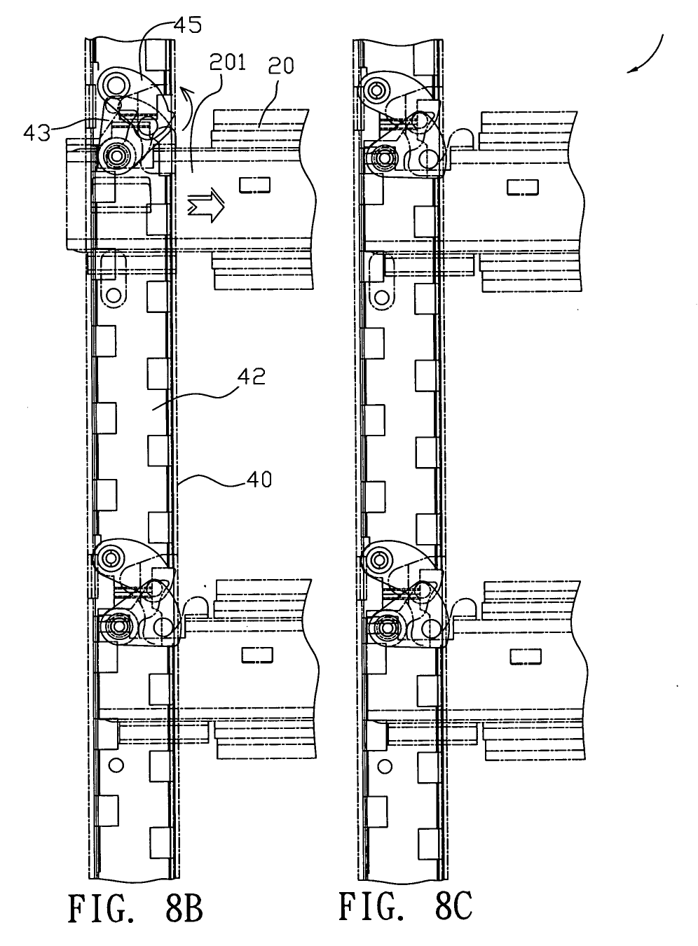

Referring to FIGS. 8A, 8B and 8C, if a drawer 30 (not shown in the figure) is pushed inward, the rail 201 connected to the drawer 30 will move inward accordingly to drive the latch 431 to be latched into the embedding groove 221 again and will press an edge of the embedding groove 221 and use the pivotal shaft 44 as an axle center to move circumferentially downward. In the meantime, the protruding pillar 432 is driven to move the linking element 45 accordingly and drive the upper moving elements 42 to move downward and resume their original positions.

Since the latching element 43 and the linking element 45 are eccentrically and pivotally connected to the moving elements 42, the latching element 43 and the linking element 45 can be moved smoothly, and the moving elements 42 can be moved in a minimum moving distance. The invention can prevent the occurrence of unable to move the latching element 43 to its desired position due to the insufficient moving space, so that the drawer 30 will not be moved outward while other drawers 30 are moving.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation, the present invention enhances the performance than the conventional structure and further complies with the patent application requirements and is duly filed for the patent application.

What is claimed is:

1. A fixing apparatus for preventing drawers from being linked and slid, comprising:
a cabinet;
a support stand, fixed separately and correspondingly on both lateral inner sides of said cabinet;
a plurality of bottom rails, fixed on said support stand, and said each bottom rail having a rail embedded therein, and said rails can be coupled with said drawers, and said rail has a fixing base fixed at an end of said rail, and said fixing base has an embedding groove disposed thereon;
a fixing element, being erected adjacent to said support stand, and having an open slot and a slide slot corresponding to each other;
a plurality of moving elements, erected vertically and adjacently in said fixing element;
a plurality of latching elements, eccentrically and pivotally connected to an end by a pivotal shaft, and having a latch protruded from a side of said each latching element, and said latches can be latched into said embedding groove of said fixing base;
a plurality of linking element, eccentrically and pivotally coupled to another end of said moving elements by a pivotal shaft, and pivotally coupled with said adjacent latching elements;
such that if a drawer is pulled outward, said rail coupled to said drawer will be pulled out accordingly to drive a latch in said embedding groove to move a latch in said fixing base out from said embedding groove, and an edge of said embedding groove will be pressed, and said pivotal shaft is used as an axle center to move upward circumferentially and drive said linking element to move accordingly, and said upper moving elements will move upward to latch said upper drawers with said corresponding latching elements and preventing said upper drawers from moving outward.

2. The fixing apparatus for preventing drawers from being linked and slid of claim 1, wherein said latching element and said moving elements can be pivotally coupled by a protruding pillar disposed on a surface without said latch and along an axis other than said latch and said pivotal shaft.

3. The fixing apparatus for preventing drawers from being linked and slid of claim 1, wherein said moving element includes a protruding member protruded from said fixing element, and said fixing element includes a slide slot corresponding to said protruding member, and said protruding member is passed through a lower edge in said slide slot, such that if a drawer is pulled outward, said lower moving elements will not be moved downward, and said lower drawers will be latched to said corresponding latching elements and will not be moved outward.
